(19) United States
(12) Patent Application Publication
(10) Pub. No.: US 2013/0169430 A1
(43) Pub. Date: Jul. 4, 2013

(54) APPARATUS AND METHOD FOR SMOKE DETECTION & ALARM

(71) Applicant: Joe Shook, Apache Junction, AZ (US)

(72) Inventor: Joe Shook, Apache Junction, AZ (US)

(21) Appl. No.: 13/339,346

(22) Filed: Dec. 28, 2011

(51) Int. Cl. G08B 17/10; G08B 1/08

(52) U.S. Cl. 340/539.1; 340/628

(57) ABSTRACT

The present invention comprises a smoke detector/alarm unit with user configurable settings. The smoke detector/alarm is equipped with one or more sets of lights that, depending on the orientation of the smoke detector/alarm: shine a beam of light to the floor downward through the smoke; illuminate an exit path to safety from the building for the occupants of the building; provide infrared illumination for the fire fighters who may enter the building to assist during evacuation or controlling a potential fire. An optional radio frequency (“RF”) transmitter may also be activated to trigger the illumination of additional lights for further illumination of an exit path to safety from the building for the occupants of the building.

### BACKGROUND OF THE INVENTION

1. Technical Field

The present invention generally relates to systems for monitoring and more specifically relates to monitoring systems for residential and commercial fire detection and alarms.

2. Background Art

In general, a smoke detector is a device that detects smoke, typically as an indicator of fire. The use of smoke detectors and related devices, including CO₂ detectors and heat detectors, is well known in the art. These devices are typically installed in most new commercial and residential buildings. Most building codes will specify exactly which devices must be installed and will often, in the case of commercial buildings, mandate periodic testing as well.

Commercial, industrial, and multi-family residential devices may be configured to issue a signal to a centralized fire alarm system, which may be transmitted to one or more third party central stations who may, in turn, dispatch the fire department, while household smoke detectors, typically known as smoke alarms, generally issue only a local audible and/or visual alarm from the detector itself. Some residential systems are also connected to third party monitoring systems as well, usually on a subscription basis.

In the United States of America, smoke detectors are typically housed in a disk-shaped plastic enclosure approximately 150 mm (˜6 inches) in diameter and 50 mm (˜2 inches) thick, but may be of any shape and design and the exact size and shape can vary by manufacturer or product line. Most smoke detectors work either by optical detection (e.g. photoelectric detection) or by a physical process (e.g. ionization), while some smoke detectors use multiple detection methods to increase sensitivity to smoke. Smoke detectors in large commercial, industrial, and residential buildings are usually powered by a central fire alarm system, which is powered by the building power with a battery backup. However, in many single family detached and smaller multiple family housings, a smoke alarm is often powered by an interconnected 120V AC system with disposable 9 v batteries installed for back up power. A single light emitting diode (“LED”) is often used as a power indicator. If the battery loses too much power, an audible alert or “chirping” sound will emanate from the smoke detector to warn of the impending power loss. In the case where smoke is detected, the smoke alarm will sound an alarm to warn the occupants in the building about the potential hazardous condition.

While certainly useful, the present devices are not without their limitations. For example, currently known devices are not designed for certain eventualities that frequently occur during a building fire, particularly where fire fighters are required to enter smoke filled buildings. Accordingly, without improvements to the current state of the art for the monitoring and detection of fires, the operation of these systems will continue to be suboptimal.

### BRIEF SUMMARY OF THE INVENTION

The present invention comprises a smoke detector/alarm unit with user configurable settings. The smoke detector/alarm unit is equipped with one or more sets of lights that, depending on the orientation of the smoke detector/alarm: shine a beam of light to the floor downward through the smoke; illuminate an exit path to safety from the building for the occupants of the building; provide infrared illumination for the fire fighters who may enter the building to assist during evacuation or controlling a potential fire. An optional wireless transmitter may also be activated to trigger the illumination of additional lights for further illumination of an exit path to safety from the building for the occupants of the building.

### BRIEF DESCRIPTION OF THE FIGURES

The preferred embodiments of the present invention will hereinafter be described in conjunction with the appended drawings, wherein like designations denote like elements, and:

FIG. 1 is a block diagram for a smoke detector/alarm unit in accordance with a preferred exemplary embodiment of the present invention;

FIG. 2 is a schematic diagram of an LED light array for use in conjunction with a smoke detector/alarm unit in accordance with a preferred exemplary embodiment of the present invention;

FIG. 3 is a table depicting one set of possible options that may be associated with an LED light segment array for use in conjunction with a smoke detector/alarm unit in accordance with a preferred exemplary embodiment of the present invention.

FIG. 4 is a method for detecting smoke and activating an alarm using a smoke detector/alarm unit in accordance with a preferred exemplary embodiment of the present invention; and

FIG. 5 is a schematic representation of the exterior casing of a smoke detector/alarm unit in accordance with a preferred exemplary embodiment of the present invention, depicting a preferred location and orientation for a plurality of lights.

### DETAILED DESCRIPTION

The present invention comprises a smoke detector/alarm unit with user configurable settings. The smoke detector/alarm is equipped with one or more sets of lights that, depending on the orientation of the smoke detector/alarm: shine a beam of light to the floor downward through the smoke; illuminate an exit path to safety from the building for the occupants of the building; provide infrared illumination for the fire fighters who may enter the building to assist during evacuation or controlling a potential fire. An optional radio frequency (“RF”) transmitter may also be activated to trigger the illumination of additional lights for further illumination of an exit path to safety from the building for the occupants of the building.

The most preferred embodiments of the present invention will comprise three separate light sources: amber LED lights for visual indicators to building occupants; infrared lights for visual indicators to firefighters or other emergency response personnel; and an LED light array for battery power indication. Each of these light sources has been selected for a specific reason and application to increase the viability of the smoke detector/alarm unit described herein.

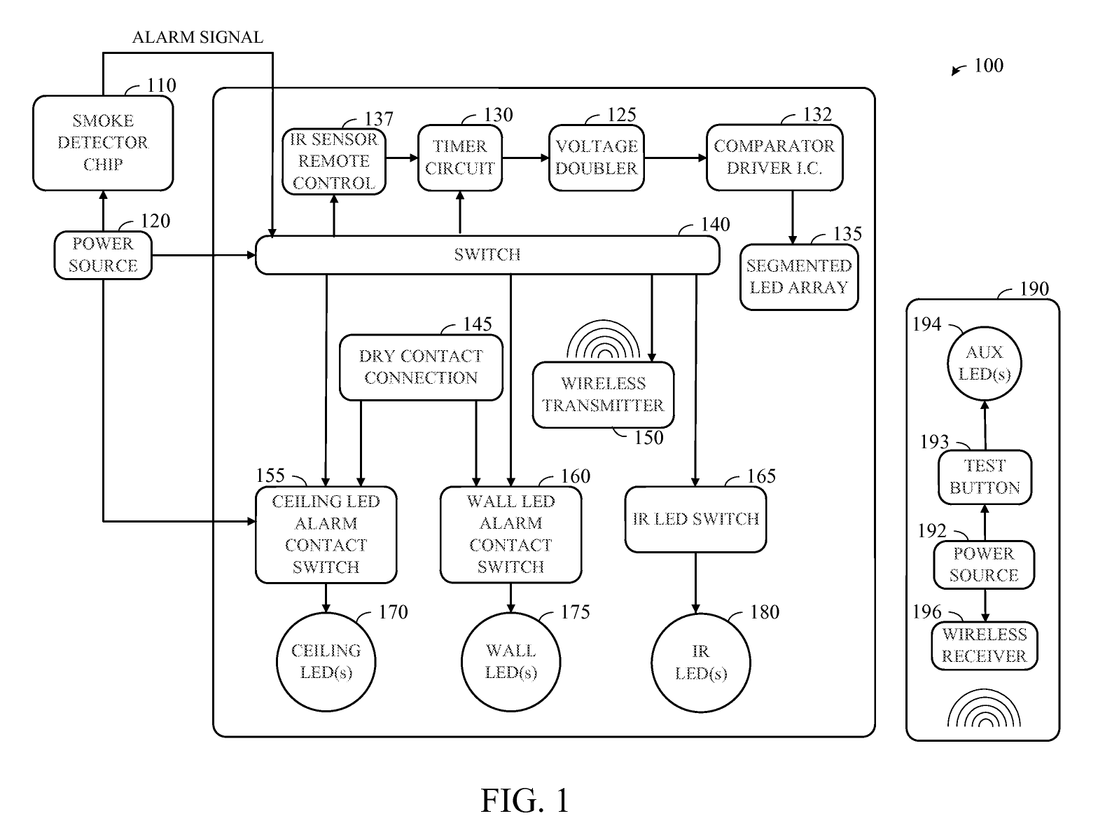

Referring now to FIG. 1, a block diagram for a smoke detector/alarm 100 in accordance with a preferred exemplary embodiment of the present invention comprises: a smoke detector chip 110; a power source 120; a voltage doubler 125; a timer circuit 130; a comparator/driver 132: a light emitting diode (“LED”) array 135; an infra-red (IR”) sensor 137; a user-configurable switch 140; a dry contact connection 145; an optional wireless transmitter 150; a ceiling LED contact switch 155; a wall LED contact switch 160; an IR LED contact switch 165; one or more ceiling LEDs 170; one or more wall LEDs 175; and one or more IR LEDs 180. For purposes of this disclosure, IR generally refers to light sources operating at a wavelength that are not discernible by the human eye.

Additionally, for at least one preferred embodiment of the present invention, a wireless transmitter controllable auxiliary LED light source 190 may be included. As shown in FIG. 1, auxiliary LED light source 190 most preferably comprises a power source 192 coupled to one or more auxiliary LEDs 194 through a test switch 193 and a wireless receiver 196 inside the smoke detectors to transmit wirelessly to the LED stairway lighting project.

Smoke detector chip 110 comprises a monitoring circuit including various elements used in many existing smoke detector units, e.g., a control circuit (microprocessor or discrete analog components, etc.), sensor (photoelectric or ionization) to sense the smoke and a piezoelectric buzzer or alarm capable of producing an audible alarm loud enough to wake people up during an alarm condition. Unit 100 may employ either or both of a standard photoelectric sensor or an ionization chamber that is configured to detect the smoke from a fire or smoldering object. Any type of sound including a buzzer, horn, or other audible signal may be produced by the internal piezoelectric alarm for purposes of providing a warning signal, provided that the audible signal is loud enough to rouse someone from their sleep. As shown in FIG. 1, an alarm signal, signifying smoke detected by smoke detector chip 110 can be used to provide notification of the alarm condition to the other components of unit 100.

Power source 120 comprises any type of power source that may be used to provide appropriate levels of electrical energy to power the components of unit 100. Most standard smoke detectors are configured to be powered by a 9-volt battery, 120-volt current (“VAC”), or both. Power source 120 is electrically connected to and configured to provide power to the various components of unit 100.

Voltage doubler 125 is provided to adjust the voltage level supplied to comparator driver integrated circuit (“IC”) 132 and then to LED array 135. The use of voltage doubler 125 is optional, depending on the specific components selected by the manufacturer of unit 100 but is depicted here so as to communicate the possible need for various additional components as necessary for connectivity and stability of electrical power supplies to the various components of unit 100.

Timer circuit 130 is most preferably an adjustable digital timing circuit or device that provides the power for comparator driver IC 132 that, in turn, controls the illumination of LED array 135. Since LED array 135 consumes a more significant amount of power than a single LED, the more preferred embodiments of the present invention will use timer circuit 130 to periodically (e.g., every 30-45 seconds) illuminate LED array 135. Low power LED lights are available and, depending on the application, may be used in LED array 135.

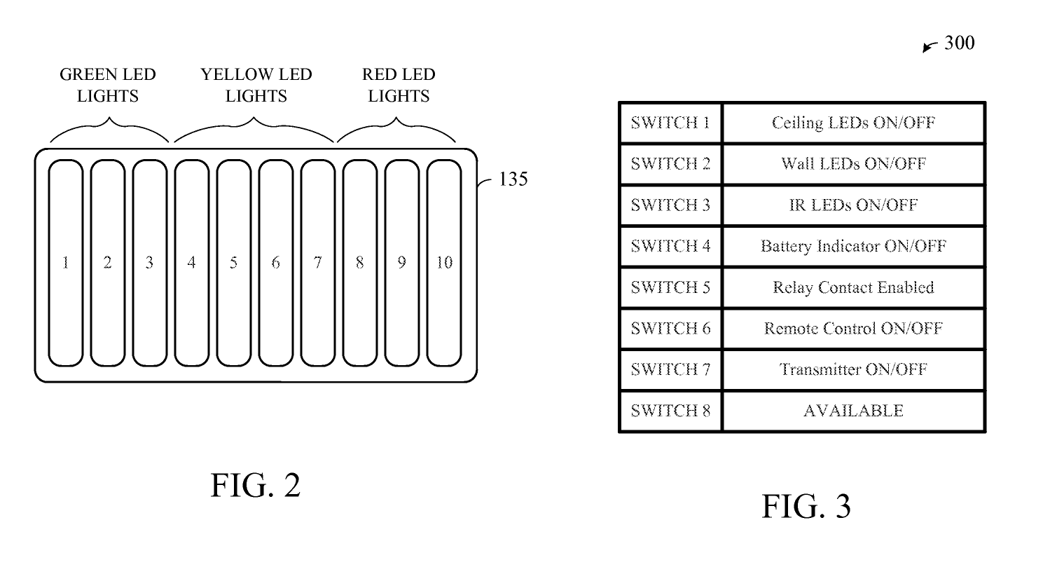

Light emitting diode (“LED”) array 135 is most preferably a 10 segment LED array with 3 different colors (e.g., red, yellow, and green) that is configured to act as a battery indicator to indicate the level of battery charge remaining. Additional information about light emitting diode (“LED”) array 135 is provided in conjunction with FIG. 2 below. In certain preferred embodiments of the present invention, voltage doubler circuit 125 may also be coupled to an IR receiver 137. In this embodiment of the invention, whenever an IR light source (e.g. television remote control) is detected by IR receiver 137 for a pre-determined period of time (e.g., 2-4 seconds), IR receiver 137 will generate a signal to comparator/driver IC 132 and LED array 135, and the appropriate LED segment of LED array 135 will be illuminated.

This approach may obviate the need for timer circuit 130 since the battery level can be checked on an ad-hoc, as needed basis. Additionally, should the end user choose to hold the remote control button for a longer pre-determined period of time (e.g., 5-10 seconds), than IR receiver 137 may be configured to initiate a complete audible and visual test of the system. Additionally, the building occupant may use the IR function to “reset” a false alarm condition and silence the piezoelectric alarm. This can be accomplished by using the IR light source to provide an IR light to the IR receiver for a predetermined period of time (e.g., 30 seconds) and the alarm condition will be temporarily reset. However, should the circumstances which initiated the alarm condition persist after the alarm has been reset, the alarm will be re-activated.

User-configurable switch 140 is most preferably a dual inline package (“DIP”) switch with at least 6-8 two-position switch options. While more or fewer positions may be used, the fewer the number of switch positions, the fewer the number of options. The more positions used, the larger the physical size of the switch so the number of switches should be kept to a minimum so as to keep the overall size of unit 100 as small as practicable. The DIP switch has been selected for inclusion primarily due to its low cost and simplicity of implementation. While described herein as a DIP switch, those skilled in the art will recognize that switch 140 may be any of a wide variety of switches, including analog and digital switches (e.g., programmable gate array, etc.) and no switch is excluded from consideration.

By selecting the position of the switches in the DIP switch, the user can selectively enable or disable certain user-configurable options. For example, the user can select which LED lights to have illuminated during an alarm condition. For a ceiling mount application of unit 100, it is generally most effective to have ceiling LEDs 170 illuminated. For a wall mount application of unit 100, it is generally most effective to have wall LEDs 175 illuminated. In certain applications, it may be desirable to have both ceiling LEDs 170 and wall LEDs 175. Proper configuration of switch 140 allows for these and other options. Additional available options are explained in the table of FIG. 3.

Dry contact connection 145 is provided as a connection point for connecting unit 100 to one or more other devices or locations, thereby creating a more comprehensive smoke detection system. For example, it may be desirable to connect unit 100 to a remote third party monitoring service through the end users existing security and/or alarm system to provide for additional monitoring of the facility where unit 100 is installed. Additionally, for certain applications, it may be desirable to connect multiple units 100 in a daisy chain fashion.

Optional wireless transmitter 150 is most preferably a wireless transmitter and is configured for wireless communication with one or more auxiliary light sources 190. When an appropriate alarm condition is received by unit 100, a wireless signal is transmitted to each auxiliary light source 190. Upon receiving the signal from optional wireless transmitter, one or more auxiliary LEDs 150 will be illuminated. In the most preferred embodiments of the present invention, auxiliary LEDs 150 comprise a pair of high-powered amber colored LED lights. Those skilled in the art will recognize that there are many types of wireless communication hardware and communication protocols the may be suitably employed for this purpose. The selection of the wireless hardware and communication protocol will depend on factors such as cost, distance for signal transmission, etc.

Ceiling LED contact switch 155 is an electrical connection point that selectively activates or deactivates the connection to ceiling LEDs 170, depending on the status of switch 140 and whether or not an alarm condition is present. By setting the appropriate configuration in switch 140, the user can determine whether or not ceiling LEDs 170 will be illuminated when an alarm condition occurs.

Wall LED contact switch 160 is an electrical connection point that selectively activates or deactivates the connection to wall LEDs 175, depending on the status of switch 140 and whether or not an alarm condition is present. By setting the appropriate configuration in switch 140, the user can determine whether or not wall LEDs 175 will be illuminated when an alarm condition occurs.

Infra-red (IR”) LED contact switch 165 is an electrical connection point that selectively activates or deactivates the connection to IR LEDs 180, depending on the status of switch 140 and whether or not an alarm condition is present. By setting the appropriate configuration in switch 140, the user can determine whether or not IR LEDs 180 will be illuminated or not whenever an alarm condition occurs.

Ceiling LEDs 170 comprise one or more LEDs that will be illuminated in an alarm condition if the user has installed unit 100 on a ceiling (e.g., unit 100 is mounted in a substantially horizontal position) and selected the appropriate settings using switch 140. In this application, the LEDs are more preferably one or more high-powered amber colored LED lights. Amber has been selected as the most preferable color for since Ceiling LEDs 170 it will be more visible in smoke-filled environments.

Wall LEDs 175 comprise one or more LEDs that will be illuminated in an alarm condition if the user has installed unit 100 on a wall (e.g. unit 100 is mounted in a substantially vertical position) and selected the appropriate settings using switch 140. In this application, the LEDs are more preferably one or more high-powered amber colored LED lights. Amber has been selected as the most preferable color for since Ceiling LEDs 170 it will be more visible in smoke-filled environments.

IR LEDs 180 are most preferably LED light sources that emit LED light in the normally non-visible light spectrum. In an alarm condition, IR LEDs 180 will be illuminated, and emit LED light. Many firefighters and other emergency personnel are equipped with IR goggles, for low-light conditions. In this fashion, IR LEDs 180 will provide additional illumination for the firefighters and other emergency personnel when entering a building during an alarm condition.

Auxiliary light source 190 is most preferably an LED light source positioned along a desired exit path that will quickly and efficiently guide a person from a building in case of emergency. This may be accomplished via the use of hard-wired components or battery operated components. In the most preferred embodiments of the present invention, auxiliary light source 190 is one or more high-powered amber-colored LED lights. Amber has been selected as the most preferable color for since ceiling LEDs 170 it will be more visible in smoke-filled environments. In an alarm condition, wireless transmitter 150 will send a wireless signal to auxiliary light source 190, activating auxiliary LEDs 194. In the most preferred embodiments of the present invention, it is anticipated that multiple auxiliary light sources 190 will be positioned in enclosures (e.g., gang boxes or 120 VAC electrical outlets) at various strategic locations through a building, thereby providing additional light for the occupants of the building during a smoke-filled hazardous situation. Additionally, directional light blinds or covers may be installed over the gang boxes to provide a directional light source, if desired. Also, each gang box may comprise a test button that, when depressed, will allow the user to verify that power source 192 and LEDs 170 are functional.

Referring now to FIG. 2, an LED light array 200 in accordance with a preferred exemplary embodiment of the present invention comprises an array of LED light segments, configured as a battery power level indicator. In the most preferred embodiments of the present invention, a single LED light segment of LED light array 200 will be illuminated on a periodic basis, as controlled by timer circuit 130 of FIG. 1. The specific LED segment that will be illuminated will be correlated to the level of charge associate with power source 120 of FIG. 1.

For example, when power source 120 is at full strength, the leftmost LED segment (No. 1) will be illuminated for a pre-determined period of time (e.g., every 30-45 seconds). As the battery charge diminishes over time, the LED segment selected for illumination will gradually and sequentially move from left to right. Eventually, the yellow LED segments (e.g., 4, 5, 6, and 7) will be illuminated and then the red LED segments (e.g. 8, 9, and 10). This visual indicator provides a very simple way for a person to determine the appropriate time to change the battery in unit 100 of FIG. 1 before the detector begins to chirp, similar to a fuel gauge on an automobile, and will provide a more positive experience for the building occupants since the probability of being awakened in the middle of the night by a “chirping” sound will be diminished or eliminated.

Referring now to FIG. 3, is a table 300 depicting one set of possible options that may be associated with an LED light segment array for use in conjunction with a smoke detector/alarm unit in accordance with a preferred exemplary embodiment of the present invention is depicted. By positioning the individual DIP switches in the appropriate user-configurable options can be activated or deactivated. For example, in this case, the position 1 switch may be used to engage or disengage the operation of ceiling LEDs 170. Similarly, the position 2 switch may be used to engage or disengage the operation of wall LEDs 175 and the position 3 switch may be used to engage or disengage the operation of IR LEDs 180. With these switches in the “on” position, the LEDs will be illuminated whenever an alarm condition is signaled. In the “off” position, the associated LEDs will not be illuminated at any time. Similarly, the other user-configurable options may be enabled or disabled by positioning the appropriate switch in the appropriate position.

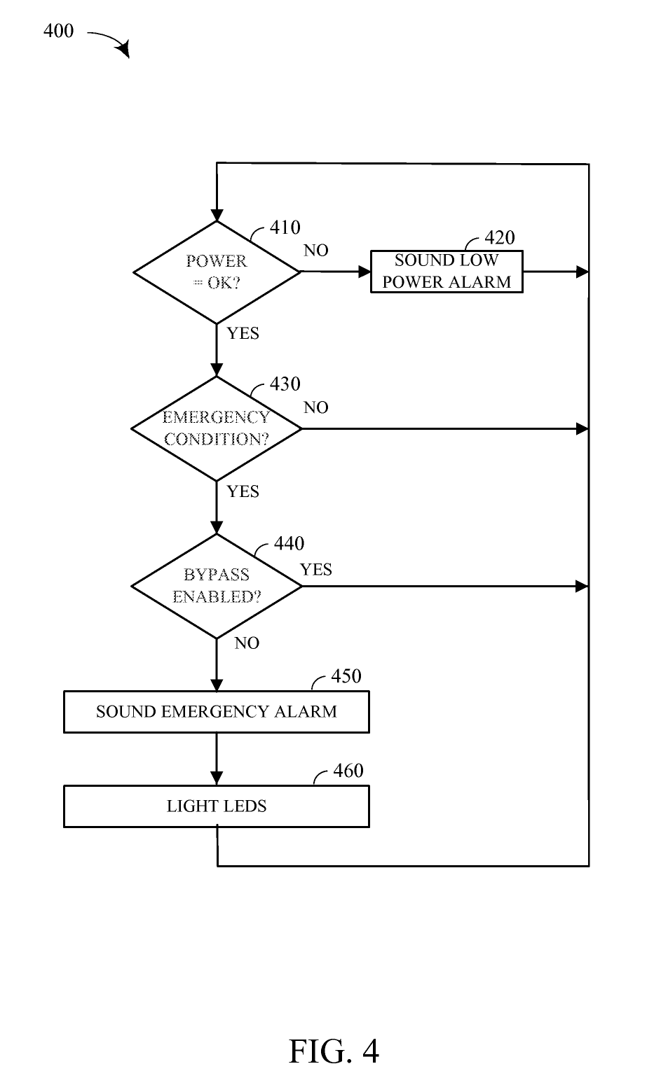

Referring now to FIG. 4, a method 400 for detecting smoke and activating an alarm using a smoke detector/alarm unit in accordance with a preferred exemplary embodiment of the present invention is depicted. As shown in FIG. 4, unit 100 of FIG. 1 operates in a continual cycle, checking for important operational characteristics. Unit 100 periodically checks to determine whether or not the power source is functional and remains capable of operating unit 100 (step 410=“YES”). If the power source is not functional (step 410=“NO”) then the low power alarm will be activated (step 420).

Similarly, unit 100 is continually checking for the presence of smoke (typically above a predetermined threshold level) or some other emergency condition such as the presence of carbon monoxide or carbon dioxide (step 430). If an emergency condition does not exist (step 430=“NO”), then unit 100 continues to cycle, checking for power and battery conditions. However, if an emergency condition exists (step 430 “YES”) then unit 100 will determine whether or not the bypass function has been enabled (step 440). If the bypass function has been enabled (step 440=“YES”), then unit 100 will continue to cycle as before. However, if the bypass function has not been enabled (step 440=“NO”) then the emergency alarm will be activated (step 450) and the designated LED lights will be activated (step 460). The actual LED lights to be activated will be determined by the settings of switch 140 of FIG. 1 but any or all of the lights associated with unit 100 as described herein may be activated, as desired.

It should be noted that the steps depicted in method 400 are not the only activities taking place during the normal operation of unit 100. For example, as previously mentioned, LED array 135 is constantly being updated and the appropriate LED segment is being displayed as part of step 410 according to the timing sequence dictated by timer circuit 130.

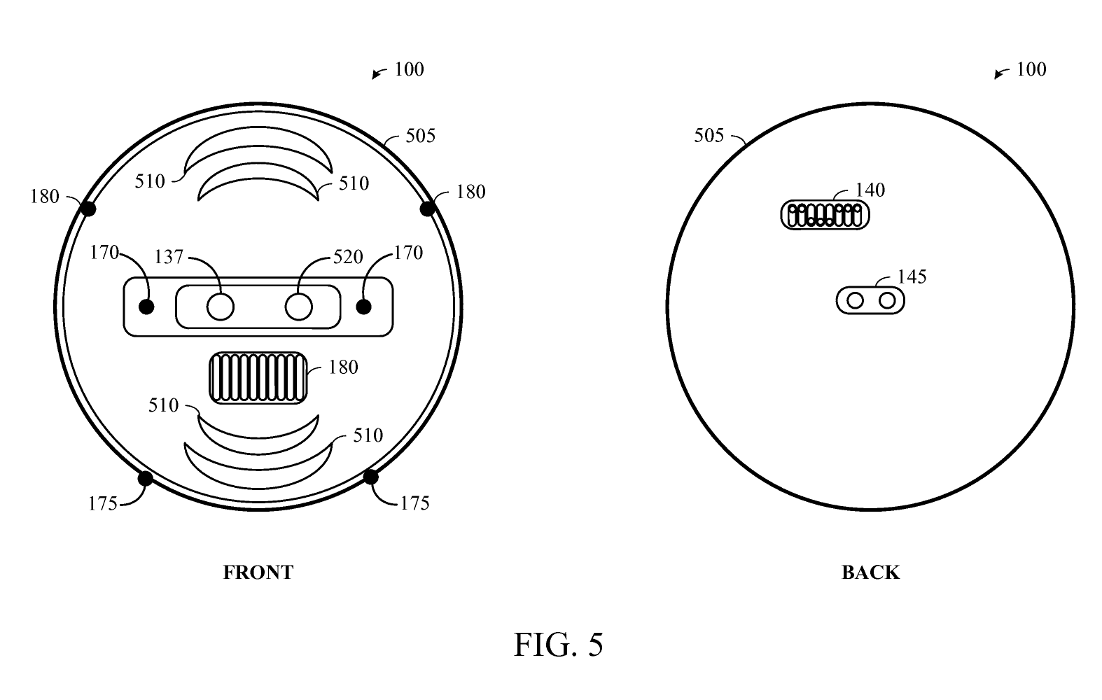

Referring now to FIG. 5, a schematic representation of the exterior case or housing 505 for the components of smoke detector/alarm unit 100 of FIG. 1 in accordance with a preferred exemplary embodiment of the present invention is depicted. A front portion and a back portion are depicted. The front portion represents the viewable surface of unit 100, whether unit 100 is mounted on a wall or on a ceiling. Similarly, the back portion of unit 100 is the portion that faces the wall or the ceiling, depending on the installation environment. In either case, the back portion will not be visible unless unit 100 is removed from the wall or ceiling. Case or housing 505 is similar in size and shape to existing smoke detectors and may be manufactured from any suitable material, including flame and heat resistant plastics. Case or housing 505 is manufactured using techniques and processes known to those skilled in the art.

As shown in FIG. 5, case or housing 505 of unit 100 provides a mounting structure for wall LEDs 175, ceiling LEDs 170, and IR LEDs 180. In addition, apertures 510 are formed in case or housing 505 of unit 100 and provide openings for smoke to enter the smoke sensor contained within housing 505. Further, in at least one preferred embodiment of the present invention, a “push to test” button 520 is included so that the functional operation of unit 100 can be tested and verified on a periodic basis. When pressing button 520, if unit 100 is operational, the alarm condition warning sound will be produced. It should be noted that additional features such as decorative elements, standard mounting holes formed in housing 505, and similar features may be included, but are not shown for the sake of clarity.

From the foregoing description, it should be appreciated that enhanced apparatus and methods for smoke detection and alarm are provided by the various preferred embodiments of the present invention and that the various preferred embodiments offer significant benefits that would be apparent to one skilled in the art. Furthermore, while multiple preferred embodiments have been presented in the foregoing description, it should be appreciated that a vast number of variations in the embodiments exist. For example, certain preferred embodiments of the present invention may comprise additional sensors for sensing other types of hazardous situations and conditions (e.g., CO₂ or CO gas detectors).

Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims.

What is claimed is:

1. An apparatus comprising:
a housing;
a power source contained with the housing;
a monitoring circuit coupled to the power source and contained within the housing;
a user configurable switch contained within the housing; and
at least one amber LED light source and at least one IR LED light source affixed to the housing and controlled by the user configurable switch.

2. The apparatus of claim 1 wherein the at least one amber LED light source comprises a plurality of amber LED light sources.

3. The apparatus of claim 1 wherein the at least one IR LED light source comprises a plurality of IR LED light sources.

4. The apparatus of claim 1 further comprising a wireless transmitter, the wireless transmitter transmitting a signal to at least one remote LED light source and causing the at least one remote LED light source to be illuminated upon the detection of an alarm condition by the monitoring circuit.

5. The apparatus of claim 1 further comprising a piezoelectric alarm, the piezoelectric alarm being activated upon the detection of an alarm condition by the monitoring circuit.

6. The apparatus of claim 1 further comprising:
an IR receiver; and
a segmented LED display affixed to the housing and coupled to the IR receiver, at least one segment of the segmented LED display being illuminated upon receipt of a signal from the IR receiver.

7. The apparatus of claim 1 wherein the at least one amber LED light source comprises a plurality of wall mount LED light sources and a plurality of ceiling mount LED light sources and wherein only one of the wall mount LED light sources and a plurality of ceiling mount LED light sources are illuminated upon the detection of an alarm condition by the monitoring circuit and a setting of user the configurable switch.

8. The apparatus of claim 1 further comprising:
an IR sensor;
a timer circuit coupled to the IR sensor
a voltage doubler coupled to the timer circuit;
a comparator driver coupled to the voltage doubler; and
a segmented LED display coupled to the comparator driver, at least one segment of the segmented LED display being illuminated upon receipt of a signal from the IR sensor.

9. The apparatus of claim 1 further comprising:
a piezoelectric alarm, the piezoelectric alarm being activated upon the detection of an alarm condition by the monitoring circuit
an IR receiver;
a segmented LED display coupled to the IR receiver, at least one segment of the segmented LED display being illuminated upon receipt of a signal from the IR receiver;
wherein the at least one amber LED light source comprises a plurality of amber LED light sources;
wherein the at least one IR LED light source comprises a plurality of IR LED light sources

10. A smoke detector comprising:
a power source;
a monitoring circuit coupled to the power source;
a user configurable switch;
a piezoelectric signal coupled to the power source, the piezoelectric signal being activated upon the detection of an alarm condition by the monitoring circuit;
at least one amber LED light source coupled to the power source and the user configurable switch, the at least one amber LED light source being activated upon the detection of an alarm condition by the monitoring circuit;
at least one IR LED light source coupled to the power source and the user configurable switch, the at least one IR LED light source being activated upon the detection of an alarm condition by the monitoring circuit;
an IR receiver coupled to the power source;
a segmented LED display coupled to the power source and the user configurable switch and to the IR receiver, at least one segment of the segmented LED display being activated by the IR receiver upon the receipt of an IR signal from an IR transmitter; and
a wireless transmitter coupled to the power source, the wireless transmitter activating at least one remote light source upon detection of an alarm condition by the monitoring circuit.

11. The smoke detector of claim 10 wherein the at least one IR LED light source comprises a plurality of IR LED light sources.

12. The smoke detector of claim 10 wherein the at least one amber LED light source comprises a plurality of amber LED light sources.

13. The smoke detector of claim 10 wherein the at least one IR LED light source comprises a plurality of IR LED light sources and wherein the at least one amber LED light source comprises a plurality of amber LED light sources.

14. A method comprising the steps of:
monitoring for an alarm condition with a monitoring circuit; and
activating at least two of a plurality of light sources based on at least one user-configurable switch setting and the detection of an alarm condition.

15. The method of claim 14 wherein the step of monitoring for an alarm condition with a monitoring circuit comprises the step of monitoring for a level of smoke above a pre-determined threshold.

16. The method of claim 14 wherein the step of activating at least two of a plurality of light sources based on at least one user-configurable switch setting and the detection of an alarm condition comprises the steps of:
activating a plurality of IR LED light sources; and
activating a plurality of amber LED light sources.

17. The method of claim 14 further comprising the step of activating a piezoelectric alarm based on at least one user-configurable switch setting and the detection of an alarm condition.

18. The method of claim 14 further comprising the step of activating at least one remote light source upon detection of an alarm condition by the monitoring circuit.

19. The method of claim 14 further comprising the step of activating at least one segment of a segmented LED display based upon the receipt of a wireless IR signal.

20. The method of claim 14 wherein the step of activating at least two of a plurality of light sources based on at least one user-configurable switch setting and the detection of an alarm condition comprises the steps of:
activating at least one remote light source upon detection of an alarm condition by the monitoring circuit;
activating a plurality of IR LED light sources upon detection of an alarm condition by the monitoring circuit;
activating a plurality of amber LED light sources upon detection of an alarm condition by the monitoring circuit; and
activating a piezoelectric alarm based on at least one user-configurable switch setting and upon detection of an alarm condition by the monitoring circuit.
